(19) United States
(12) Patent Application Publication
(10) Pub. No.: US 2013/0198629 A1
(43) Pub. Date: Aug. 1, 2013

(54) TECHNIQUES FOR MAKING A MEDIA STREAM THE PRIMARY FOCUS OF AN ONLINE MEETING

(71) Applicants: Ankit Tandon, Bellevue, WA (US); Prarthana Panchal, Seattle, WA (US)

(72) Inventors: Ankit Tandon, Bellevue, WA (US); Prarthana Panchal, Seattle, WA (US)

(73) Assignee: MICROSOFT CORPORATION, Redmond, WA (US)

(21) Appl. No.: 13/360,673

(22) Filed: Jan. 28, 2012

(51) Int. Cl. G06F 3/01

(52) U.S. Cl. 715/716

(57) ABSTRACT

Techniques for managing video streams in an online conference event are described. An apparatus may comprise a media content manager component and a media selection component. The media content manager component is operative on a logic device to generate a composite media stream from a plurality of media streams received from a multimedia conference server for a multimedia conference event. The media selection component is operative on the logic device to select a primary media stream from the plurality of media streams based on selection by the participant. The apparatus may also comprise a visual media generator component which is operative to receive the selected primary media stream and map the selected primary media stream to a primary display frame on the display device.

### BACKGROUND

A multimedia conference or meeting system typically allows multiple participants to communicate and share different types of media content in a collaborative and real-time meeting environment. The multimedia conference system may display different types of media content using various graphical user interface (GUI) windows or views. For example, one GUI view may include video images of participants, another GUI view might include presentation slides, yet another GUI view might include text messages between participants, and so forth. In this manner, various geographically disparate participants may interact and communicate information in a virtual meeting environment over a network similar to a physical meeting environment where all the participants are within one room.

In certain virtual meeting environments utilizing online meeting tools, each participant may have the ability to view each of the plurality of GUI windows or views. For example, each participant may have the ability to view video streams from each of the other participants as well as a video stream of a collaborative whiteboard. However, the meeting organizer or presenter is usually the GUI view that is the focus of the meeting and may occupy a predominant portion of the participant's display device with the video streams of the other participants displayed around the periphery. In this instance, the control of what video stream is viewed by a participant is controlled at the server side of the meeting event. However, this does not enable a participant to control, on the client side, which of the video streams the participant would like to view as the primary video stream while keeping all the other video streams in the periphery. Another type of virtual meeting environment allows the “presenter” designation to be passed from participant to participant to focus the meeting participants on their particular GUI view which may include a shared document, computer screen, shared desktop, video feed, etc. However, this type of virtual meeting restricts which of the GUI views each participant may focus on depending on which participant is designated as the presenter at any given time which is usually controlled on the server side of the system. Alternatively, the GUI view that is associated with a participant that is the loudest talker may occupy a predominant portion of the participant's display device with the video streams of the other participants, including the presenter/organizer, disposed around the periphery. The determination of which participant is the loudest talker may be controlled by the organizer or presenter on the server side of the system. However, this GUI view does not enable a participant to focus on a video stream from the plurality of video streams available during the online meeting of the participant's choice on the client side of the system. A system and method directed to improving display techniques in a virtual meeting environment may therefore enhance user experience and convenience.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments may be generally directed to multimedia conference systems. Some embodiments may be particularly directed to techniques to generate a visual composition or GUI view for a multimedia conference event. The multimedia conference event may include multiple participants, some of which may gather in a conference room, while others may participate in the multimedia conference event from a remote location. A participant may receive a plurality of media streams corresponding to media information from one or more of the participants in the multimedia conference event. The participant may select one or more of the media streams as the primary media stream to be displayed as a visual composition on his/her own display device.

In one embodiment, for example, an apparatus may comprise a logic device, a media content manager component and a media selection component. The media content manager component is operative on the logic device to generate a composite media stream from a plurality of media streams for a multimedia conference event on a display device for one of a plurality of participants. The media selection component is operative on the logic device to select a primary media stream from the plurality of media streams based on selection by the one of the plurality of participants. The apparatus may also comprise a visual media generator component which is operative to receive the selected primary media stream and map the selected primary media stream to a primary display frame on the display device. Other embodiments are described and claimed.

### BRIEF DESCRIPTION OF THE DRAWINGS

FIG. 1 illustrates an embodiment of a multimedia conference system.

FIG. 2 illustrates an embodiment of a meeting component.

FIG. 3 illustrates an exemplary functional block diagram of a multimedia conference system.

FIG. 4a illustrates an embodiment of a visual composition.

FIG. 4b illustrates an embodiment of a visual composition.

FIG. 5a illustrates an embodiment of a visual composition.

FIG. 5b illustrates an embodiment of a visual composition.

FIG. 6 illustrates an embodiment of a logic flow.

FIG. 7 illustrates an embodiment of a computing architecture.

FIG. 8 illustrates an embodiment of a communications architecture.

### DETAILED DESCRIPTION

In a typical virtual meeting environment, the primary display may be controlled by a meeting organizer or presenter where the participants can only see, as the primary display, that which the organizer or presenter selects. However, a participant may want to focus on a particular media stream or visual display that is different from the primary display as dictated by the conference organizer or presenter. To solve these and other problems, various embodiments are generally directed to techniques to generate a visual composition for a multimedia conference event which allows each participant to select a media stream as the primary visual display on the participant's display device at any time during the conference event with the remaining media streams arranged in the periphery. In particular, the online multimedia conference system is configured to allow an online conference participant the ability to select any multimedia content stream from a plurality of multimedia content streams comprising the online conference or meeting to be the participant's primary focus on the participant's display. The selected multimedia content stream may be any of the media streams supplied by the participants during the multimedia conference and may be more than one media stream. The multimedia content may be, for example, a video stream generated from a camera associated with each participant, a data file associated with an application program, a desktop screen sharing application or any other multimedia content stream to be viewed by the meeting participants.

The online multimedia conference or meeting system includes a multimedia conference server configured to receive each of the media streams during an online meeting via a network and send the received media streams to each participant. Each of the media streams may be mapped to a one or more of a plurality of display frames on the participant's display device. These display frames may be arranged on the participant's display device in various configurations depending on the type of participant's display device. Typically, at least one of the media streams received by a participant will be displayed in a display frame of a GUI view as the primary focus of the multimedia conference and the remaining video streams may be arranged in display frames around the periphery of this primary media stream. An online multimedia conference system enables each participant to select any one or more of the plurality of video streams to be the primary focus of the multimedia conference as determined by the participant. In this manner, a multimedia conference participant may select any of the multimedia content streams received by a participant as the primary focus for their GUI view during the conference event.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

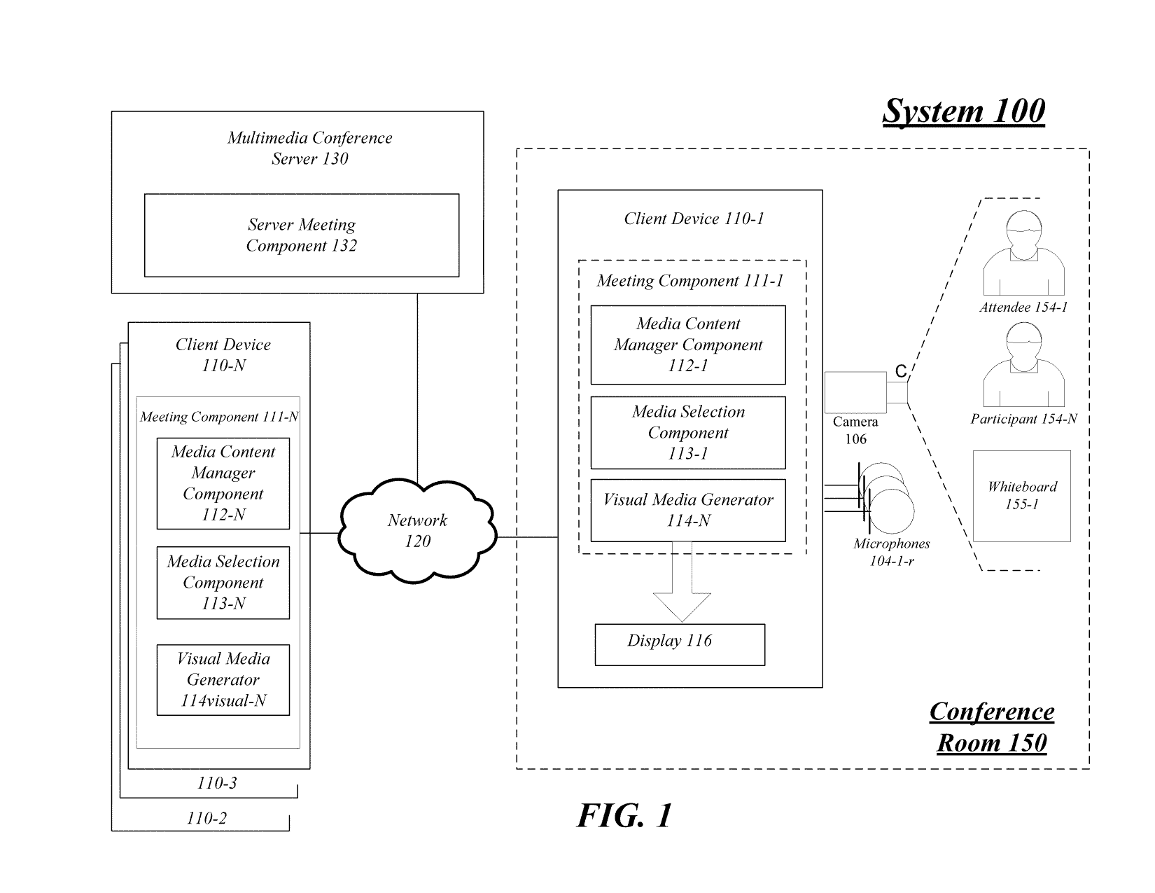

FIG. 1 illustrates a block diagram of a multimedia conference system 100. Multimedia conference system 100 may represent a general system architecture suitable for implementing various embodiments. An example of a multimedia conferencing system may include MICROSOFT® OFFICE LIVE MEETING, MICROSOFT OFFICE COMMUNICATOR, MICROSOFT® LYNC™. Multimedia conference system 100 includes a plurality of client devices 110-1 . . . 110-N where “N” herein is a positive integer and a multimedia conference server 130 communicating with each of the client devices via network 120. It is worthy to note that the use of “N” for different devices or components of the multimedia conference system 100 does not necessarily imply a same number of different devices or components.

The multimedia conference system 100 may be arranged to communicate, manage or process different types of information, such as media information and control information among the client devices 110-1 . . . 110-N during a multimedia conference event. A multimedia conference event may refer to an event that shares various types of multimedia information in a real-time or live online environment, and is sometimes referred to herein as simply a “meeting event,” “multimedia event” or “multimedia conference event.” Examples of media information may generally include any data representing content meant for a user, such as voice information, video information, audio information, image information, textual information, numerical information, application information, alphanumeric symbols, graphics, data files and so forth. Media information may sometimes be referred to herein as “media content” as well. Control information may refer to any data representing commands, instructions or control words meant for an automated system. For example, control information may be used to route media information through system 100, to establish a connection between a client device (110-1 . . . 110-N) and multimedia conference server 140, instruct a client device (110-1 . . . 110-N) to process the media information in a predetermined manner, and so forth. Each of the client devices 110-1 . . . 110-N may also act as a meeting console where a client device may be used to communicate with a plurality of attendees during a multimedia conference event. Client device 110-1 is an example of a client device that acts as a meeting console since attendees 154-1 . . . 154-N participate in a multimedia conference event in conference room 150 via the client device 110-1, but the client device 110-1 may or may not belong to any one of the participants 154-1 . . . 154-N.

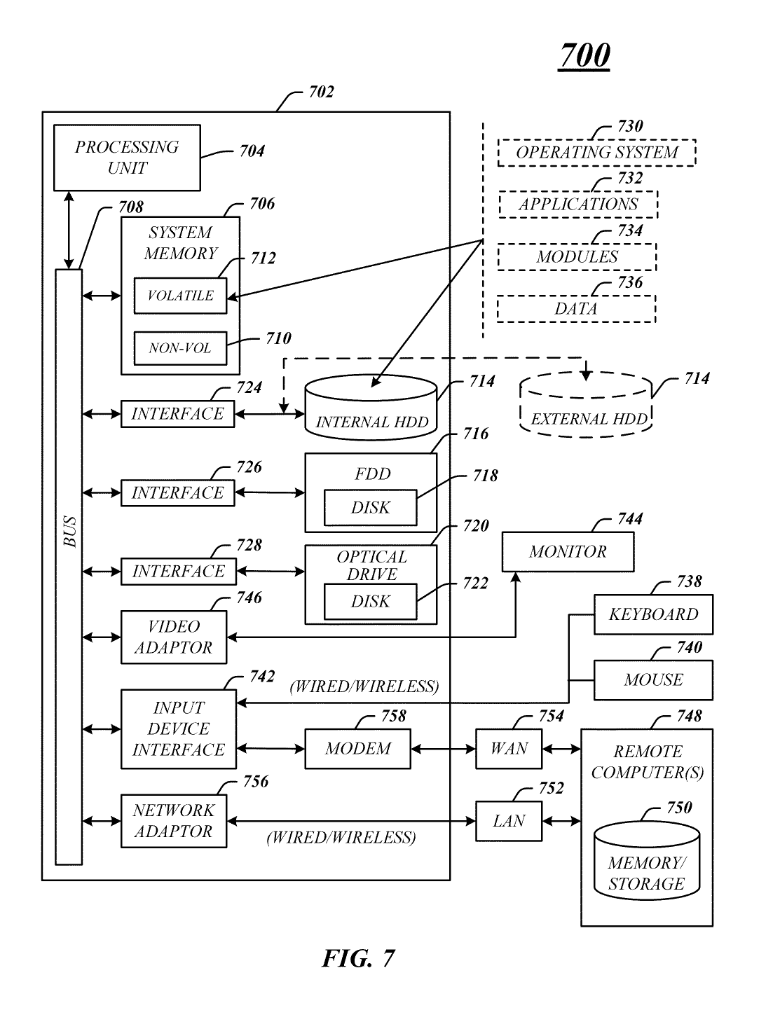

The client devices 110-1 . . . 110-N may comprise any logical or physical entity that is arranged to participate or engage in a multimedia conference event managed by the multimedia conference server 130. The client devices 110-1 . . . 110-N may be implemented as any device that includes, in its most basic form, a processing system including a processor and memory, one or more multimedia input/output (I/O) components, and a wireless and/or wired network connection to communicate with network 120. The multimedia I/O components are configured to provide the media content which are processed by the client devices 110-1 . . . 110-N to generate respective media content streams that are sent to the multimedia conference server 130 via network 120. Examples of such multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of such client devices 110-1 . . . 110-N may include without limitation a personal computer (PC), mobile device, a personal digital assistant, a mobile computing device, a smart phone, a computer, a desktop computer, a laptop computer, a notebook computer, a handheld computer, a tablet computer, a server, a work station, a mini-computer, a distributed computing system, a multiprocessor system, a processor-based system, a gaming device, consumer electronics, a television, a digital television, combinations thereof, and/or web renderings of the foregoing. In some implementations, the client devices 110-1 . . . 110-N may be implemented using a general or specific computing architecture similar to the computing architecture described herein with reference to FIG. 7.

Each of the client devices 110-1 . . . 110-N provides a media stream representing the media content generated from the multimedia I/O components and supplies these media streams to multimedia conference server 130 via network 120. The multimedia conference server 130 operates as a central server that controls and distributes media information from each of the media content streams from client devices 110-1 . . . 110-N in the multimedia conference event. Multimedia conference server 130 receives the media streams from the client devices 110-1 . . . 110-N, performs mixing operations for the multiple types of media information, and forwards the media streams to some or all of the participants. The multimedia conference server 130 may comprise any logical or physical entity that is arranged to establish, manage or control a multimedia conference event between client devices 110-1 . . . 110-N over a network 120. The multimedia conference server 130 may comprise or be implemented as any processing or computing device, such as a computer, a server, a server array or server farm, a work station, a mini-computer, and so forth.

The multimedia conference server 130 may comprise or implement a general or specific computing architecture suitable for communicating and processing the media information received from the client devices 110-1 . . . 110-N. In one embodiment, for example, the multimedia conference server 130 may be implemented using a computing architecture as described with reference to FIG. 7. Examples of the multimedia conference server 130 include MICROSOFT SHAREPOINT SERVER, MICROSOFT WINDOWS LIVE SKYDRIVE®, MICROSOFT LYNC™ SERVER, etc. It may be appreciated, however, that implementations are not limited to these examples. In addition, a specific implementation for the multimedia conference server 130 may vary depending upon a set of communication protocols or standards to be used for the multimedia conference event. Various signaling protocols may be implemented for the multimedia conference server 130 that still fall within the scope of the embodiments.

In general operation, multimedia conference system 100 may be used for multimedia conference calls. Multimedia conference calls typically involve communicating voice, video, and/or data information among the users of client devices 110-1 . . . 110-N. For example, network 120 may be used for audio conferencing calls, video conferencing calls, audio/video conferencing calls, collaborative document sharing and editing, and so forth. To establish a multimedia conference call over network 120, each client device 110-1 . . . 110-N may connect to multimedia conference server 130 via network 120 using various types of wired or wireless communications links operating at varying connection speeds or bandwidths. The client devices 110-1 . . . 110-N and the multimedia conference server 130 may establish media connections using various communications techniques and protocols including, for example, the SIP series of protocols for VoIP signaling over packet-based networks (e.g., public networks such as the Internet, private networks such as an enterprise intranet, and so forth). The SIP series of protocols are application-layer control (signaling) protocols for creating, modifying and terminating sessions with one or more client devices 110-1 . . . 110-N. Once the connection is established between the client devices 110-1 . . . 110-N and the multimedia conference server 130, the multimedia information may be transferred therebetween via one or more transport protocols such as, for example, Transmission Control Protocol (TCP), User Datagram Protocol (UDP), UDP Lite, Datagram Congestion Control Protocol (DCCP), Stream Control Transmission Protocol (SCTP), and so forth. One or more participants may join a multimedia conference event by connecting to the multimedia conference server 130. The multimedia conference server 130 may implement various admission control techniques to authenticate and add users and client devices 110-1 . . . 110-N in a secure and controlled manner.

As noted above, the multimedia conference server 130 receives the media streams from the client devices 110-1 . . . 110-N, performs mixing operations for the multiple types of media information, and forwards the media streams to some or all of the client devices 110-1 . . . 110-N. Each of the client devices receives the media streams and processes the media information using respective meeting components 111-1 . . . 111-N. A display device 116 associated with each of the client devices 110-1 . . . 110-N receives the media streams as processed by the meeting components 111-1 . . . 111-N and displays the media information, usually, as a mosaic on the display device 116. For example, video streams from all or a subset of the client devices 110-1 . . . 110-N may be displayed as a mosaic on display 116 with a center frame displaying video for the current active speaker, and a panoramic view of the other participants in other frames around the center frame. A participant and/or user of the client device 110-1 . . . 110-N may select a particular one of the media streams to be the primary focus of their respective display device 116 and the other media streams not designated as the primary focus may be arranged around the periphery of the primary focused media stream as described in more detail below. In this manner, a multimedia conference participant 110-1 . . . 110-N may select any of the received media content streams as the primary focus for that participant's display device 116 during a multimedia conference event.

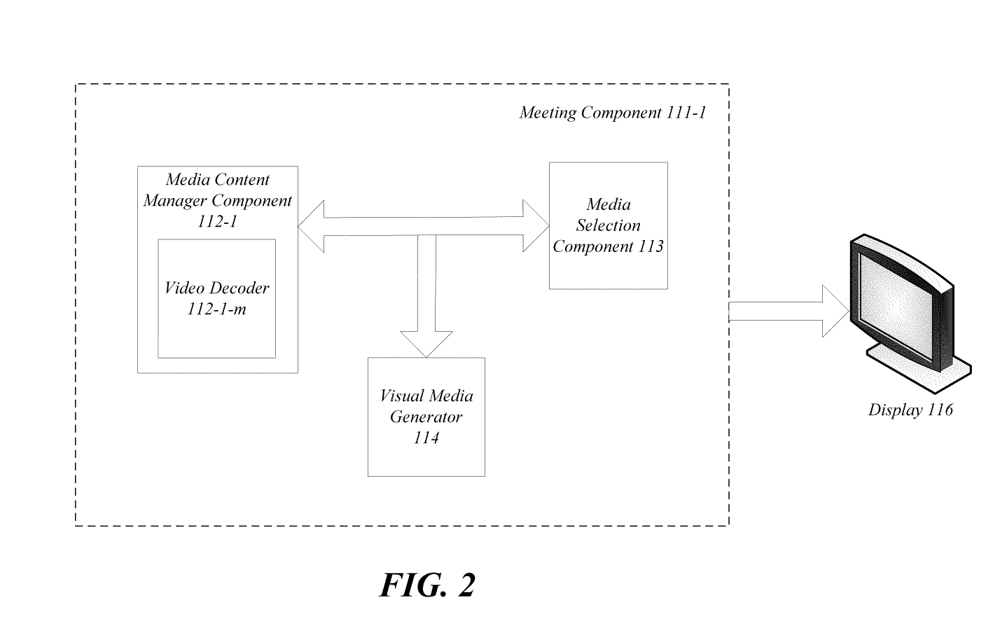

The client devices 110-1 . . . 110-N may comprise or implement respective meeting components 111-1 . . . 111-N which may be designed to interoperate with a server meeting component 132 of the multimedia conference server 130. The meeting components 111-1 . . . 111-N may generally operate to generate, manage and display a visual composition for a multimedia conference event on display 116 for a particular participant or user. For example, the meeting components 111-1 . . . 111-N may comprise or implement the appropriate application programs and user interface controls to allow the respective client devices 110-1 . . . 110-N to participate in a conference event facilitated by the multimedia conference server 130. Each meeting component 111-1 . . . 111-N may include a media content manager component 112-1 . . . 112-N, a media selection component 113-1 . . . 113-N, and a visual media generator 114-1 . . . 114-N respectively. Each of these components interact to receive the media streams from multimedia conference server 130, allow a user to select one or more of these media streams as the primary media stream, and display the selected primary media stream on display 116 in a particular GUI view as described in more detail with reference to FIG. 2.

As shown in the illustrated embodiment of FIG. 1, the multimedia conference system 100 may include a conference room 150. An enterprise or business typically utilizes conference rooms to hold meetings. Such meetings include multimedia conference events having participants located internal to the conference room 150, and remote participants located external to the conference room 150. The conference room 150 may have various computing and communications resources available to support multimedia conference events, and provide multimedia information between one or more remote client devices 110-2 . . . 110-N and the local client device 110-1. The conference room 150 may include a local client device 110-1 located internal to the conference room 150. The local client device 110-1 may include various multimedia input devices arranged to capture media content from the conference room 150. The local client device 110-1 includes a video camera 106 and an array of microphones 104-1-r. The video camera 106 may capture video content including video of the participants 154-1, 154-N as well as a video of traditional whiteboard 155-1 present in the conference room 150, and stream this content to the multimedia conference server 130 via the local client device 110-1. It should be noted that the whiteboard 155-1 may be representative of a data file associated with an application file to be shared among the participants, a video, a webpage, a photograph, or other media information source. Similarly, the array of microphones 104-1-r may capture audio content including audio content from the participants 154-1, 154-N present in the conference room 150, and stream the audio content to the multimedia conference server 130 via the local client device 110-1. The local client device 110-1 may also include various media output devices, such as a display 116 or video projector, to show one or more GUI views with video content or audio content from all the participants using the client devices 110-1 . . . 110-N received via the multimedia conference server 130.

FIG. 2 illustrates a block diagram for an exemplary meeting component 111-1 from client device 110-1. As noted above, each client device 110-1 . . . 110-N may comprise or implement respective meeting components 111-1 . . . 111-N designed to receive a plurality of media streams representing media information and display this information in a format based on selection by a multimedia conference event participant. In particular, an exemplary meeting component 111-1 may include a media content manager component 112-1, a media selection component 113-1 and a visual media generator 114-1. The media content manager component 112-1 . . . 112-N is operative to generate a composite visual display from the plurality of media streams received from multimedia conference server 130. The media content manager component 112-1 . . . 112-N may comprise various hardware elements and/or software elements arranged to generate a visual composition on display 116. The media content manager component 112-1 includes a video decoder 112-1-m which may generally decode media streams received from multimedia conference server 130. In one embodiment, for example, the video decoder 112-1-m may be arranged to receive input media streams from various client devices 110-1 . . . 110-N participating in a multimedia conference event. The video decoder 112-1-m may decode the input media streams into digital or analog video content suitable for display by the display 116. Further, the video decoder module 112-1-m may decode the input media streams into various spatial resolutions and temporal resolutions suitable for the display 116 and the display frames used by visual media generator 114 to produce a visual composition of the received media streams.

The media content manager component 112-1 . . . 112-N integrates and aggregates different types of multimedia content related to each participant in a multimedia conference event, including video content, audio content, identifying information, and so forth. For example, the media content manager component 112-1 . . . 112-N may be configured to receive all the media streams and display the media information corresponding to each media stream in display frames of equal size on display device 116. Alternatively, the media content manager component 112-1 . . . 112-N may be configured to receive all the media streams and display the media information corresponding to a particular participant's media stream in a center display frame and the remaining media streams around the periphery of this center display frame in a mosaic format. It should be noted that the media content manager component 112-1 . . . 112-N filters a user's own media content stream from being displayed on the user's own display 116. For example, if a user of client device 110-2 utilizes a webcam to provide video images of the user in front of his/her client device, then media content manager component 112-2 corresponding to client device 110-2 filters this media content stream from appearing on the users display since the user does not need to see his/her own image. Alternatively, multimedia conference server 130 and more particularly the server meeting component 132 may filter the video images received from a user of client device 110-2 from being a component of the plurality of media streams sent back to the client device 110-2.

During initialization or at the start of a media conferencing event, the media content manager component 112-1 may initially arrange the media streams that comprise a visual composition on a display device (e.g. 116) in any number of different ways. For example, the media content manager component 112-1 may arrange the media streams in a random or arbitrary manner. In another example, the media content manager component 112-1 may arrange the visual composition of the media streams in accordance with a set of selection rules, such as in order of when a participant joins the multimedia conference event. In some cases, the media content manager component 112-1 may arrange the visual composition based on a set of heuristics designed to predict those participants that are more likely to engage in presentations during the conference event or based on registration information provided by a meeting organizer. For example, certain participants (e.g. 154-1) may be designated as presenters for a multimedia conference event, while other participants (e.g. 154-2) may be designated as attendees for the multimedia conference event. Since presenters typically speak more during a multimedia conference event than attendees, the media streams from the participant designated as the presenter may be initially selected as the primary media stream. In any event, the media content manager component 112-1 may initially arrange the visual composition of the media streams and send the media streams or control information to arrange the media streams to visual media generator 114 for mapping to available display frames. At some point during the multimedia conference event, the media content manager component 112-1 may have to periodically re-configure the visual composition to display different media streams from participants to accommodate for participants joining the conference event and/or leaving the conference event.

The media selection component 113-1 . . . 113-N is operative to allow a user of a respective client device 110-1 . . . 110-N to select one or more of the plurality of media streams received from multimedia conference server 130, and processed by media content manager component 112-1 . . . 112-N as the primary media stream, and display this selected media stream within a primary display frame on the particular users display device 116. For example, if a user of client device 110-2 wants to view the media stream received from client device 110-1 as the primary media stream, the user of client device 110-2 would select the media stream corresponding to client device 110-1. In addition, the media selection component 113-1 . . . 113-N is also configured to enable a multimedia conference participant to select a media stream received from multimedia conference server 130 and processed by media content manager component 112-1 . . . 112-N as the primary media stream for all the participants of the conference. For example, a participant in the multimedia conference utilizing client device 110-2 has the ability, via media selection component 112-2 to select a media stream from the participant utilizing client device 110-3 as the primary media stream for all the participants in the conference. This ability to control the media streams viewed by the participants may be limited and may be configured during the scheduling or reserving of the multimedia conference event.

The visual media generator 114-1 . . . 114-N receives one or more media stream corresponding to the selected media stream and maps the selected media stream to a primary display frame on display device 116. Continuing with the above example, if the media stream associated with client device 110-1 is selected as the primary media stream, the media information associated with the selected media stream may be displayed in a center display frame on the user's display device 116. When more than one media stream is selected by a user of a client device 110-1 . . . 110-N as the primary media streams, the visual media generator 114-1 maps each of the selected media streams to a display frame on display device 116 which may, for example, display the primary frames side by side and the remaining media streams not selected as the primary media streams arranged in a mosaic pattern around these primary media streams. Again, the multiple media streams selected as the primary media streams for a user may include any combination of the available media streams. For example, a user may select as the primary media streams a video stream from camera 106 associated with client device 110-1 and a media stream from client device 110-2 representing an application data file shared by the user of client device 110-2. It should be noted that each of the client devices 110-1 . . . 110-N may supply more than one media stream to multimedia conference server 130. For example, client device 110-1 may supply a media stream associated with camera 106 to multimedia conference server 130 as well as a media stream associated with microphones 140-1. Although display 116 is shown as part of the client device 110-1 by way of example and not limitation, it may be appreciated that each of the client devices 110-2 . . . 110-N may include an electronic display similar to display 116 and capable of rendering a visual composition for each user of client devices 110-1 . . . 110-N.

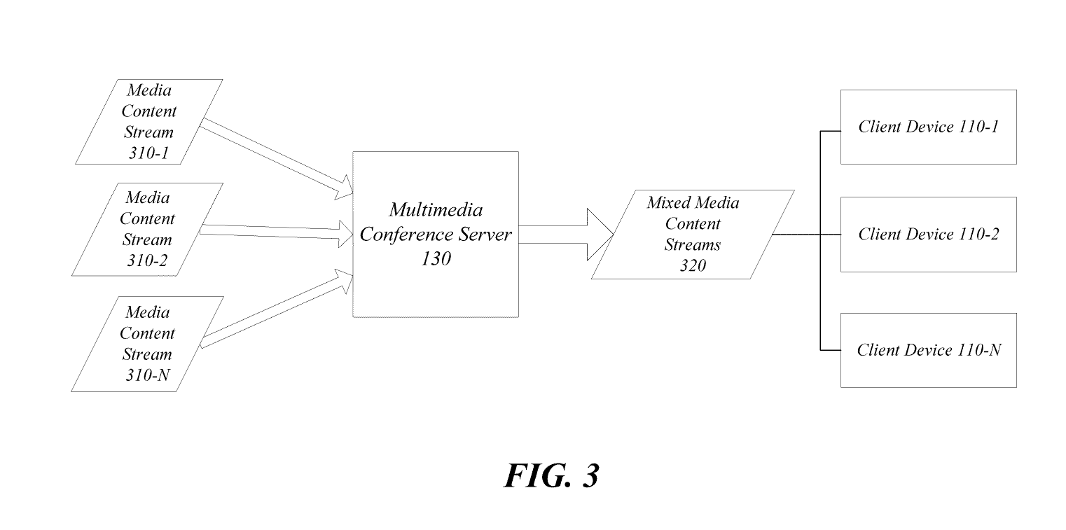

FIG. 3 is an exemplary functional block diagram of the operation of the multimedia conference system shown in FIG. 1. A plurality of media content streams 310-1 . . . 310-N supplied by respective client devices 110-1 . . . 110-N is received by multimedia conference server 130 via network 120. It should be noted that even though the plurality of media content streams 310-1 . . . 310-N is described as being associated with a respective one of client devices 110-1 . . . 110-N, a particular client device may supply more than one media content stream to multimedia conference server 130. For example, the client device 110-1 includes a video camera 106 and an array of microphones 104-1-r. The video camera 106 may capture video content and the array of microphones may capture audio from the participants in the conference room 150 and stream this content to the multimedia conference server 130. Thus, a single client device (110-1) supplies media content streams representing the video content from camera 106 and the audio content from the array of microphones 104-1-r. The multimedia conference server receives the media content streams 310-1 . . . 310-N and performs mixing operations for the multiple types of media information. The multimedia conference server 130 outputs mixed media content streams 320. Each of the client devices 110-1 . . . 110-N receives the mixed media content streams 320 from multimedia conference server 130 via network 120. The multimedia conference server 130 utilizes known communication protocols or standards noted above to receive the media content streams 310-1 . . . 310-N from respective client devices 110-1 . . . 110-N as well sending the mixed media content streams 320 to the client devices 110-1 . . . 110-N.

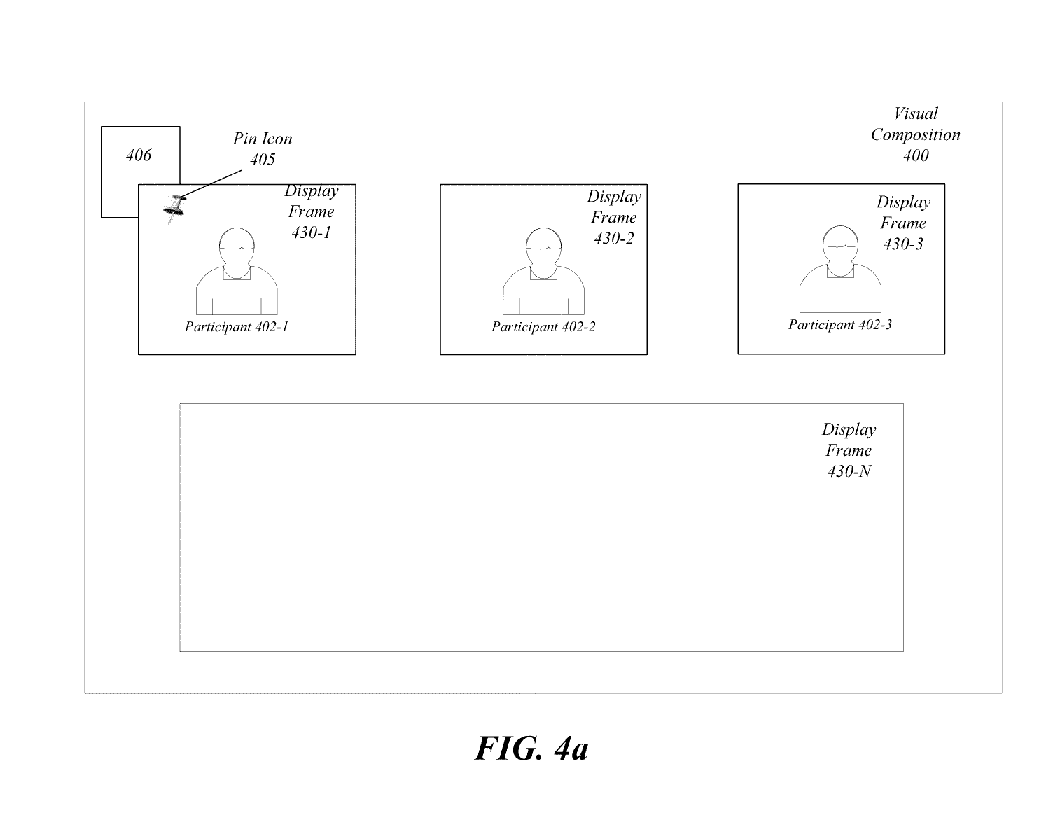

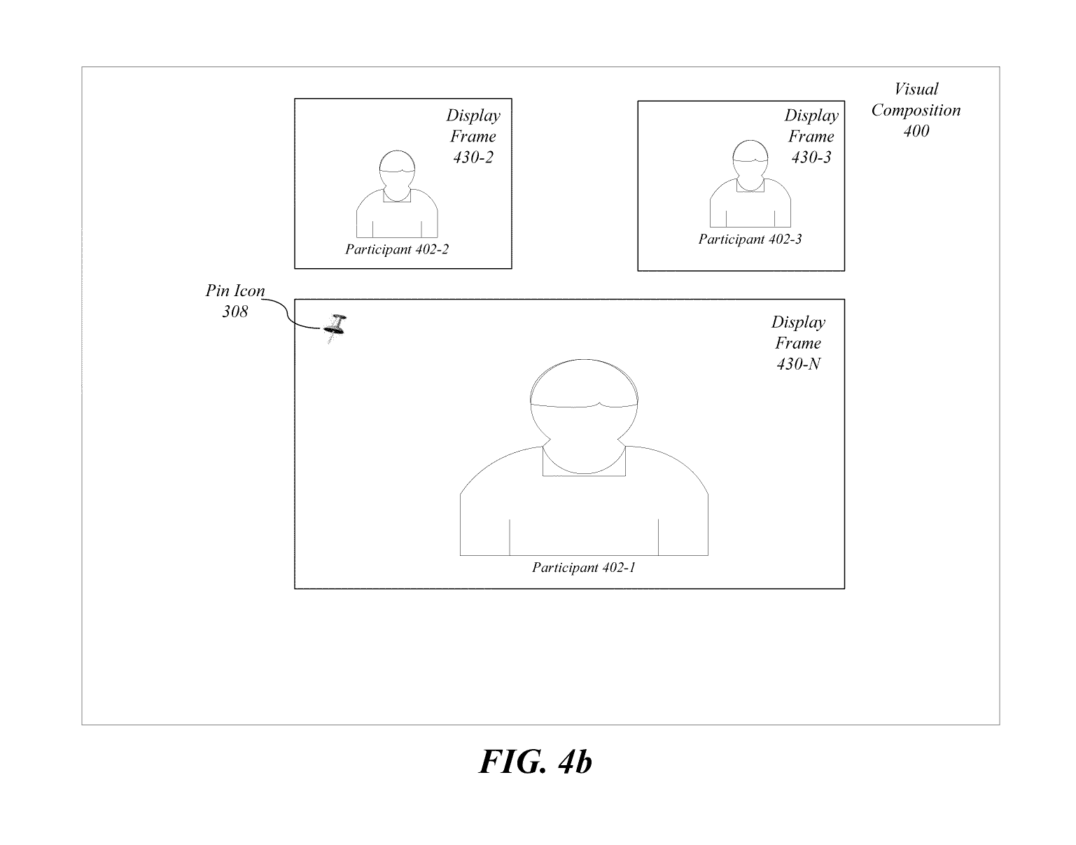

FIG. 4a illustrates an exemplary visual composition 400 that comprises various display frames 430-1 . . . 430-3 arranged in a certain mosaic or display pattern for presentation to a viewer, such as an operator of a client device 110-1 . . . 110-N and/or participants in a conference room (e.g. 150). Participants in the multimedia conference event are typically listed in a GUI view such as visual composition 400 via a display device 116. The identification of the participants 402-1 . . . 402-3 comprises a participant roster to determine who is attending the conference event. Some identifying information associated with each participant 402-1 . . . 402-3 may also be displayed as part of visual composition 400 such as, name, location, image, title, and so forth. The participants and identifying information for the participant roster is typically derived from a client device (e.g. 110-1 . . . 110-3) used to join the multimedia conference event. For example, a participant typically uses a client device to join a virtual meeting room for a multimedia conference event and, prior to joining, the participant provides various types of identifying information to perform authentication operations with the multimedia conference server 130. Once the multimedia conference server 130 authenticates the participant, the participant is allowed access to the virtual meeting room via visual composition 400, and the multimedia conference server adds the identifying information to the participant roster.

Each display frame 430-1 . . . 430-3 is designed to render or display multimedia content such as video content and/or audio content from a corresponding media stream mapped by visual media generator 114. It may be appreciated that the visual composition 400 may include more or less display frames 430-1 . . . 430-3 of varying sizes and alternate arrangements as desired for a given implementation. The display frames 430-1 . . . 430-3 display media streams that render exemplary participant images 402-1 . . . 402-3. The various display frames 430-1 . . . 430-3 may be located in a given order such as the display frame 430-1 at a first position near the top left, the display frame 430-2 in a second position to the right of display frame 430-1, and the display frame 430-3 in a third position to the right of display frame 430-2. The media streams associated with participant images 402-1 . . . 402-3 displayed by the display frames 430-1 . . . 430-3 respectively may be rendered in various formats, such as “head-and-shoulder” cutouts (e.g., with or without any background), transparent objects that can overlay other objects, rectangular regions in perspective, panoramic views, and so forth.

An operator or viewer may select a particular media stream to be displayed as the primary media stream on visual composition 400. A pin icon 405 may be embedded in the display frame associate with the media stream when a viewer of visual composition 400 selects a particular one of the display frames 430-1 . . . 430-3 as the primary media stream. The user's selection is processed by media selection component (e.g. 113-1) and the visual composition is generated by visual media generator (e.g. 114-1).

FIG. 4b illustrates an exemplary visual composition 400 where an operator or participant has selected a particular media stream to be displayed in the primary display frame 430-N. By way of example, an operator or participant may select display frame 430-1 to “pin” the display frame as the primary media stream as indicated by pin icon 405. The operator or participant may hover over the particular media stream associated with display frame 430-1 for a second or two, the pin icon 405 is embedded in the selected display frame and the particular media stream is “pinned.” Alternatively, the pin icon 405 may also be embedded in a display surface 406 adjacent or otherwise near the selected display frame associated with the media stream. It should be understood that any type of icon 405 may be used to indicate that a particular media stream has been pinned and the icon may be present anywhere within or partially within the display frame. The visual composition 400 may include a display frame 430-N comprising a primary viewing area to display the media stream associated with display frame 430-1 as the primary media stream as selected by the participant. The display frame 430-N is in a primary position in the middle of visual composition 400 occupying a relatively large portion of the visual composition as compared to the other display frames (e.g. 430-2 and 430-3). When the participant selects display frame 430-1, the visual media generator component 114 maps the selected display frame 430-1 to display frame 430-N so that the media stream associated with the display frame 430-1 becomes the primary visible element on visual composition 400. Although the primary media stream shown in display frame 430-N is illustrated as a participant image, it should be understood that any of the media streams including, for example, one or more application data files in any display frame may be selected as the primary visible element in visual composition 400 and mapped to display frame 430-N. In addition, more than one media stream may be selected by a user as the primary visible element in the visual composition 400 in which case display frame 430-N may be reduced in order to provide space in visual composition 400 to accommodate another display frame as the primary visible elements.

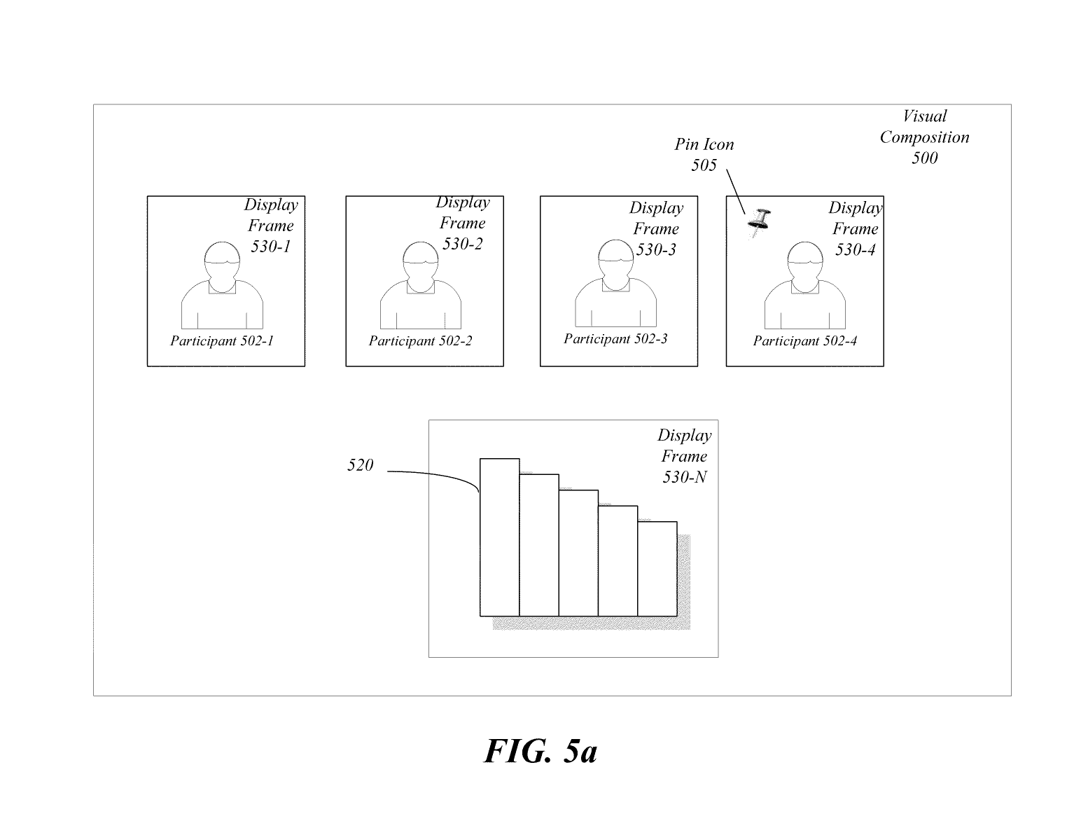

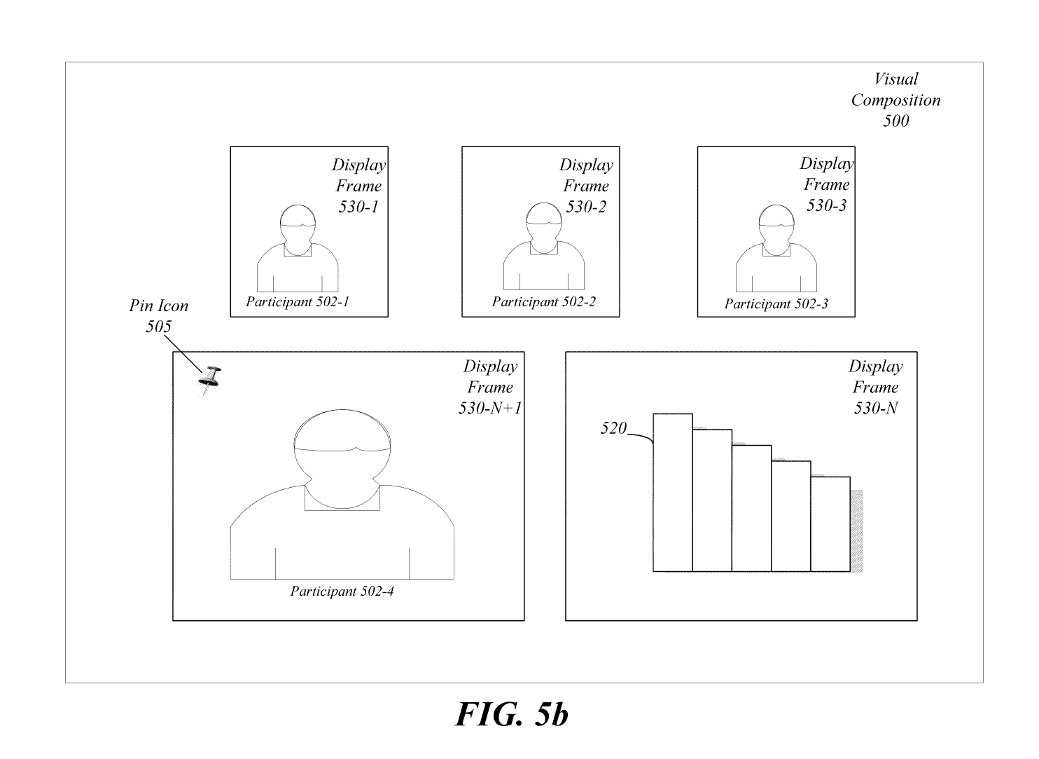

FIG. 5a illustrates an exemplary visual composition 500 that comprises various display frames 530-1 . . . 530-N and a primary display frame 530-N. Display frames 530-1 . . . 530-4 may display media streams that render exemplary participant images 502-1 . . . 502-4 respectively. The primary display frame 530-N may include content information 520 corresponding to a media stream from an application program associated with a conference participant. The various display frames 530-1 . . . 530-N may be located in a given order from a top of visual composition 500. For example, visual composition 500 may include display frame 530-1 at a first position near the top left, the display frame 530-2 in a second position next to display frame 530-1, the display frame 530-3 in a third position next to display frame 530-2 and display frame 530-4 in a fourth position next to display frame 530-3. The primary display frame 530-N may be positioned underneath the display frames 530-1 . . . 530-N and may occupy a larger area in visual composition 500 as compared to display frames 530-1 . . . 530-N. It should be understood that the arrangement of display frames 530-1 . . . 530-N shown in FIG. 5a is an example of a visual composition 500 and the embodiments are not limited to this arrangement. An operator or participant may select an additional media stream to be displayed along with an existing media stream which may together comprise the primary visible elements on visual composition 500. For example, an operator or participant may select the media stream associated with display frame 530-4 to be the primary media stream along with content information media stream 520. The operator or participant may hover over the display frame 530-4 for a second or two and the pin icon 505 is embedded in or near the display frame to indicate that the particular media stream has been “pinned.” Pin icon 505 indicates that the media stream associated with this display frame has been pinned as an additional primary media stream.

FIG. 5b illustrates an exemplary visual composition 500 where an operator or participant has selected an additional media stream to be displayed along with an existing media stream which may together comprise the primary visible elements on visual composition 500. By way of example, content information media stream 520 was previously displayed in display frame 530-N as a primary media stream in the middle of visual composition 500 and occupied a relatively large portion of the visual composition as compared to the other display frames (e.g. 530-1 . . . 530-3). An operator or participant may select display frame 530-4 to “pin” the display frame as an additional primary media stream along with content information media stream 520 as indicated by pin icon 508. The operator or participant may hover over the particular media stream associated with display frame 530-4 for a second or two, the pin icon 505 appears and the particular media stream is “pinned.”

The visual composition 500 may include an additional primary display frame 530-+1 comprising a primary viewing area in addition to display frame 530-N to display the media stream associated with display frame 530-4 as selected by the participant. The display frames 530-N and 530-N+1 are in a primary position in the middle of visual composition 500 occupying a relatively large portion of the visual composition as compared to the other display frames (e.g. 530-1, 530-2 and 530-3). When the participant selects display frame 530-4 as an additional primary media stream, s visual media generator component associated with the client device (e.g. 114) maps the selected display frame 530-4 to display frame 530-+1 so that the media stream associated with the display frame 530-4 becomes an additional primary visible element on visual composition 500. Although the additional primary media stream shown in display frame 530-N+1 is illustrated as a participant image, it should be understood that any of the media streams may be selected as another primary visible element in visual composition 500 and mapped to display frame 530-N+1.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

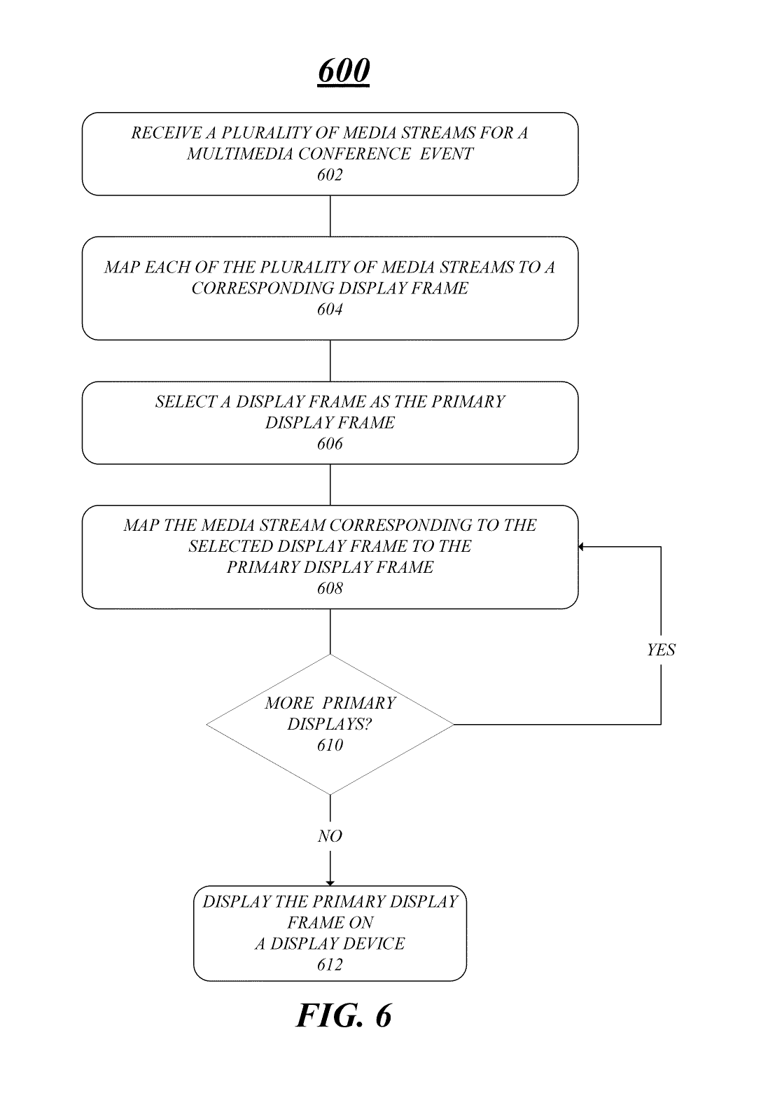

FIG. 6 illustrates one embodiment of a logic flow 600. Logic flow 600 may be representative of some or all of the operations executed by one or more embodiments described herein. As shown in FIG. 6, the logic flow 600 may receive a plurality of media streams for a multimedia conference event at block 602. For example, a plurality of media content streams 310-1 . . . 310-N supplied by respective client devices 110-1 . . . 110-N is received by multimedia conference server 130 via network 120.

The logic flow 400 may map each of the plurality of media streams to a corresponding display frame at block 604. For example, the media content manager component 112-1 may initially arrange the visual composition of the media streams and send the media streams or control information to arrange the media streams to visual media generator 114 for mapping to available display frames.

The logic flow 600 may select a display frame and the media stream associated with the display frame as the primary display frame at block 606. For example, the media selection component 113-1 . . . 113-N is operative to allow a user of a respective client device 110-1 . . . 110-N to select one or more of the plurality of media streams received from multimedia conference server 130, and processed by media content manager component 112-1 . . . 112-N as the primary media stream.

The logic flow 600 may map the media stream corresponding to the selected display frame to the primary display frame at block 608. For example, when the participant selects display frame 430-1, the visual media generator component 114 maps the selected display frame 430-1 to display frame 430-N so that the media stream associated with the display frame 430-1 becomes the primary visible element on visual composition 400.

A determination is made at block 610 as to whether or not an additional primary display was selected. For example, an operator or participant may select an additional media stream to be displayed along with an existing media stream which may together comprise the primary visible elements on visual composition 500. An operator or participant may select the media stream associated with display frame 530-4 to be the primary media stream along with content information media stream 520.

If no additional primary displays have been selected, the logic flow proceeds to block 612 where the primary display frame is displayed by a display device. If additional primary displays have been selected, the logic flow returns to block 608 where the media stream corresponding to the selected display frame is mapped to the primary display frame and the process continues to block 610 until no more primary displays have been selected by a participant.

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable storage media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, grammar builder 118, 218, 300, name processing modules 310, name normalizer 320 and speech recognizer 116, 216.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

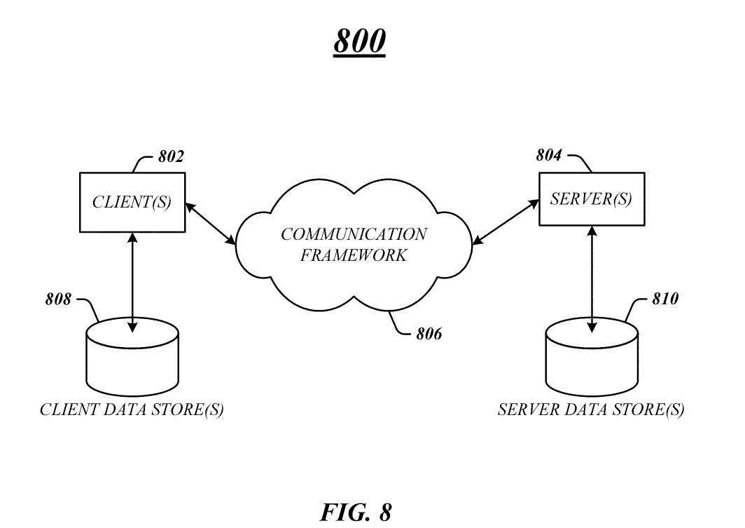

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client device 130. The servers 804 may implement the server systems for web services server 110, 210. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a logic device;
a media content manager component operative on the logic device to generate a composite visual display from a plurality of media streams for a multimedia conference event on a display device associated with one of a plurality of participants; and
a media selection component operative on the logic device to receive a control directive representing a selection, from the plurality of media streams in the composite visual display, a primary media stream as a primary display.

2. The apparatus of claim 1 further comprising a visual media generator component operative to receive the selected primary media stream and map the selected primary media stream to a primary display frame.

3. The apparatus of claim 2 wherein the visual media generator is configured to embed a visual icon associated with the selected primary display frame.

4. The apparatus of claim 3 wherein the composite visual display further comprises a display surface associated with the primary media stream, the visual media generator configured to map the visual icon to the display surface.

5. The apparatus of claim 1 wherein the visual media generator component is operative to receive the plurality of media streams from the media content manager component and map each of the plurality of media streams to a corresponding display frame.

6. The apparatus of claim 5 wherein the visual media generator component is operative to receive the selected primary media stream and map the selected primary media stream to a primary display frame such that the display frames associated with the media streams that are not associated with the primary display frame are arranged around the periphery of the primary display frame.

7. The apparatus of claim 1 wherein the media content manager component is operative to receive the plurality of media streams for the multimedia conference.

8. A computer-implemented method, comprising:
receiving a plurality of media streams for a multimedia conference;
mapping each of the plurality of media streams to a display frame on a display device; and
selecting at least one of the display frames corresponding to a media stream from the plurality of media streams to be a primary display frame on the display device based on selection of the display frame by a participant of the multimedia conference.

9. The computer-implemented method of claim 8 wherein the primary display frame is larger than the display frames that are not the primary display frame on the display device.

10. The computer-implemented method of claim 8, comprising arranging the display frames that are not the primary display frame around the periphery of the primary display frame.

11. The computer-implemented method of claim 8 wherein the primary display frame is the first primary display frame, the method comprising:
selecting a display frame that is not the first primary display frame from the display frames to be the second primary display frame based on selection by the participant;
replacing the first primary display frame with the second primary display frame; and
displaying the second primary display frame on the display device such that the second primary display frame is larger than the display frames that are not the second primary display frame on the display device.

12. The computer-implemented method of claim 11, comprising returning the first primary display frame to be displayed around the periphery of the second primary display frame.

13. The computer-implemented method of claim 8 wherein the plurality of media streams are received from a plurality of participants of the multimedia conference and the participant is a first participant, the method further comprising selecting at least one of the display frames corresponding to the media stream from the plurality of media streams to be the primary display frame on a display of each of the plurality of participants based on selection of the display frame by the first participant of the multimedia conference.

14. The computer-implemented method of claim 8 wherein at least one of the plurality of media streams is a data file associated with an application program and the primary display frame is a first primary display frame, the method further comprising:
selecting the data file associated with the application program as a second primary display frame based on selection by the participant of the multimedia conference; and
displaying the first primary display frame with the second primary display frame.

15. The computer-implemented method of claim 14 comprising displaying a remaining display frame associated with the plurality of media streams around the periphery of the first primary display frame and the second primary display frame.

16. The computer-implemented method of claim 8 wherein the primary display frame is a first primary display frame, the method further comprising:
selecting a display frame that is not the first primary display frame from the available display frames on a display device to be the second primary display frame based on selection by the participant; and
displaying the first primary display frame with the second primary display frame on the display device.

17. At least one computer-readable storage medium comprising instructions that, when executed, cause a system to:
receive a plurality of media streams for a multimedia conference;
map each of the plurality of media streams to a display frame on a display device; and
select at least one of the display frames corresponding to a media stream from the plurality of media streams to be a primary display frame on the display device based on selection of the display frame by a participant of the multimedia conference.

18. The at least one computer-readable storage medium of claim 17 further comprising instructions that when executed cause a system to arrange the display frames that are not the primary display frame around the periphery of the primary display frame.

19. The at least one computer-readable storage medium of claim 18 wherein the primary display frame is a first primary display frame, the at least one computer-readable storage medium further comprising instructions that when executed cause a system to:
select a display frame that is not the first primary display frame from the display frames to be the second primary display frame based on selection by the participant;
replace the first primary display frame with the second primary display frame; and
display the second primary display frame on the display device such that the second primary display frame is larger than the display frames that are not the second primary display frame on the display device.

20. The at least one computer-readable storage medium of claim 19 further comprising instructions that when executed cause a system to returning the first primary display frame to be displayed around the periphery of the second primary display frame.
